(19) United States
(12) Patent Application Publication
(10) Pub. No.: US 2026/0042212 A1
(43) Pub. Date: Feb. 12, 2026

(54) ADAPTIVE ROBOTIC CONTROL UTILIZING HIGH-LEVEL AND LOW-LEVEL STRATEGIES

(71) Applicant: GDM Holding LLC, Mountain View, CA (US)

(72) Inventors: David B. D'Ambrosio, Atlanta, GA (US); Saminda Wishwajith Abeyruwan, Sunnyvale, CA (US); Laura Harding Graesser, Montreal (CA); Pannag R. Sanketi, Fremont, CA (US)

(21) Appl. No.: 19/292,597

(22) Filed: Aug. 6, 2025

Related U.S. Application Data
(60) Provisional application No. 63/679,971, filed on Aug. 6, 2024.

(51) Int. Cl. B25J 9/16; A63B 69/38; G06V 20/50

(52) U.S. Cl. CPC B25J 9/1679; A63B 69/38; B25J 9/1697; G06V 20/50

(57) ABSTRACT

A method for controlling an embodied agent involves retrieving visual representations of an environment in which the agent engages in an activity. The visual representations or data derived therefrom are processed using one or more high-level control (HLC) machine learning models to generate HLC output. Based on this output, a shortlist of two or more eligible low-level control (LLC) strategies is identified from a superset of candidates. Skill descriptor metadata associated with the eligible LLC strategies is analyzed, and one strategy is selected. The visual representations or data derived therefrom are then processed using one or more LLC machine learning models associated with the selected strategy to generate LLC output. A control signal for the embodied agent is generated based on this LLC output. The activity can include racket sports, locomotion, or object manipulation.

### BACKGROUND

This specification relates to processing data using machine learning models. Machine learning models receive an input and generate an output, e.g., a predicted output, based on the received input. Some machine learning models are parametric models and generate the output based on the received input and on values of the parameters of the model. Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

Artificial intelligence has advanced significantly, leading to various methods for controlling embodied agents such as real or simulated robots, software agents, etc. Current approaches generally fall into two primary learning paradigms: reinforcement learning (RL) in simulation combined with sim-to-real techniques, and imitation learning from real-world demonstrations. Each of these paradigms presents distinct advantages and inherent limitations when applied to complex embodied agent tasks, particularly in dynamic control scenarios and precise manipulation.

Reinforcement learning in simulation offers the capability for an agent to explore a vast array of possible behaviors and acquire skills without relying on extensive human-provided examples. This approach can be particularly appealing for dynamic control tasks, such as locomotion in complex environments, where the sheer variability of situations makes direct human demonstration impractical. However, this paradigm necessitates the development of accurate and comprehensive simulators that can reliably replicate real-world physics and environmental interactions. A significant challenge lies in bridging the “sim-to-real” gap, where policies trained in a simulated environment may not translate effectively to embodied agents such as physical robots due to discrepancies between the simulated and real-world conditions. Furthermore, there is no guarantee that the data distributions on which policies are trained in simulation align precisely with the distributions encountered in real-world scenarios, potentially leading to suboptimal or unpredictable performance in actual deployments.

In contrast, imitation learning leverages real-world demonstrations, typically gathered through teleoperation, to train robotic systems. This approach directly benefits from examples that are known to successfully solve specific tasks, thereby anchoring the learning process to proven solutions. A key advantage is the bypass of the complexities associated with simulating tasks and mitigating the sim-to-real translation issues inherent in reinforcement learning. Nevertheless, imitation learning demands a substantial volume of demonstrations for each distinct task. The scale of data required can often be on the order of tens of thousands to hundreds of thousands of examples to achieve robust performance. Moreover, for certain intricate or hazardous tasks, gathering sufficient and high-quality teleoperated data presents considerable practical difficulties and resource constraints, limiting the applicability of this method for a wide range of robot functionalities.

Given these limitations, existing embodied agent control methodologies struggle to consistently achieve high-latency performance across a diverse range of complex and dynamic activities. The specialized nature of current learning paradigms, whether anchored to extensive real-world data collection or reliant on imperfect simulations, restricts the adaptability and robustness of robotic systems in varied operational environments. Therefore, a need persists for a control framework that can overcome the inherent drawbacks of current learning paradigms, enabling robotic systems to perform complex tasks with enhanced agility and precision.

In various implementations described herein, controlling an embodied agent involves retrieving visual representations and/or data derived therefrom (e.g., ball position/velocity over time), e.g., digital images captured by one or more vision sensors, screenshots, 3D renditions of a real or simulated environment, etc., where the visual data illustrates an environment in which an embodied agent performs an activity. An embodied agent can be a physical robot operating in a physical environment, a virtual robot in a simulated environment, or a software process that, for instance, automates repetitive workflows on personal computing devices. In various implementations, these visual representations—and/or data derived from the visual representations, such as ball position and/or velocity over time—may be processed using one or more high-level control (HLC) machine learning models to produce HLC output. Based on this HLC output, a shortlist of two or more eligible low-level control (LLC) strategies is identified from a broader set of candidate LLC strategies. Skill descriptor metadata associated with the eligible LLC strategies on the shortlist is analyzed, and based on this analysis, one of the eligible LLC strategies is selected. The visual representations and/or data derived therefrom may then be processed using one or more LLC machine learning models that correspond to the selected LLC strategy to generate LLC output. Finally, a control signal for the embodied agent is generated based on this LLC output.

The skill descriptor metadata associated with a given eligible LLC strategy can include empirical data about observed historical performance of that strategy. This metadata may be organized within a lookup table or a lookup tree structure in memory. The selection of an LLC strategy can also incorporate empirical data related to a co-participant in the activity, such as a human or another embodied agent, and may further consider preferences derived from this empirical data, potentially represented as a q-value.

The activity performed by the embodied agent can encompass a range of actions. For example, the activity may involve a racket sport, such as table tennis, played by the embodied agent and one or more co-participants. In such scenarios, the HLC output may identify a high-level style, such as forehand or backhand, and the visual representations may depict an incoming ball and/or data derived from the visual representations may indicate a position and/or velocity of the ball. The skill descriptor associated with an eligible LLC strategy in this context may include information such as initial ball position or velocity, hit velocity, ball landing location, or ball landing rate.

Alternatively, the activity may involve embodied agent locomotion, where the HLC output identifies a gait style from a plurality of available gait styles. The activity may also involve embodied agent manipulation of objects, where the manipulation includes a grasp of one or more objects. Here, the HLC output may identify a grip style from a plurality of grip styles or one or more target grasp points on an object. Other activities can include interaction with humans or other embodied agents, or throwing and catching an object, where the HLC output may identify a throwing style, such as overhand, underhand, side arm, hard throw, or soft toss.

The HLC and LLC machine learning models can take various forms, including convolutional neural networks (CNNs), which may be dilated-gated CNNs. In some implementations, a generative model, such as a vision language model (VLM), may be utilized. The selection of an eligible LLC strategy may also involve a degree of randomness. The visual representations can be captured by a vision sensor located on the embodied agent or by a vision sensor deployed independently in the environment. These representations may include digital images from a digital camera or point cloud data from a LIDAR sensor.

Techniques described herein may be applicable in other contexts than those already mentioned. For example, in some implementations, the activity may involve a robot playing volleyball. For instance, the system may retrieve visual representations captured by one or more vision sensors, depicting an incoming volleyball. An HLC machine learning model may process these visual representations and/or data derived therefrom (e.g., volleyball position and/or velocity over time) to generate HLC output that identifies a high-level strategy, such as a “spike,” a “block,” or a “dig.”

Based on this HLC output, the system may identify a shortlist of eligible low-level control (LLC) strategies. For a “spike” strategy, the shortlist might include an “overhead attack” (hitting the ball over the net with power) or a “tip” (gently placing the ball over the block). For a “block,” strategies could include a “single block” (one robot attempting to block) or a “double block” (two robots coordinating to block). For a “dig,” strategies might involve a “reception platform” (forming a flat surface with arms to receive a hard hit) or a “roll shot recovery” (a more agile movement to retrieve a softly placed ball).

Skill descriptor metadata associated with these eligible LLC strategies may be analyzed. For example, for an “overhead attack” strategy, the metadata could include initial ball position and velocity, robot arm trajectory, expected hit velocity, and projected ball landing location on the opponent's side of the court. For a “reception platform” strategy, metadata may include the robot's initial position relative to the incoming ball, the optimal arm angle for deflection, and the expected trajectory of the ball after contact.

Based on this analysis, one of the eligible LLC strategies is selected. For example, if the HLC output indicates a “spike” and the opponent's block is disorganized, the “overhead attack” strategy might be chosen due to its high estimated success rate and point-scoring potential. If the opponent's serve is hard and fast, the “reception platform” strategy for a “dig” might be selected to ensure a controlled pass.

The visual representations and/or data derived from the visual representations may then be processed using LLC machine learning models associated with the selected strategy to generate LLC output, such as precise joint commands for the robot's arms and torso to execute the chosen maneuver. This LLC output is used to generate a control signal for the robot, enabling it to perform the selected volleyball action. The system can adapt in real-time by updating skill descriptor metadata based on observed historical performance, adjusting its strategic choices based on the co-participant's (e.g., human opponent or teammate robot) actions and derived preferences.

In another example, the techniques described herein may be used to cause a robot to navigate a busy environment such as a crowded airport terminal. In such a case, the system could retrieve visual representations captured by one or more vision sensors, depicting the bustling terminal. A HLC machine learning model may process these visual representations or data derived from the visual representations (e.g., positions and velocities of objects in the robot's environment over time) to generate HLC output that identifies a high-level navigation style, such as “maintain speed,” “cautious traversal,” or “emergency stop.”

Based on this HLC output, the system may identify a shortlist of eligible LLC strategies. For a “cautious traversal” style, the shortlist might include “slow and steady path following” (maintaining a reduced speed while closely adhering to a planned path), “dynamic obstacle avoidance” (making small, continuous adjustments to avoid pedestrians), or “prioritize social distancing” (actively increasing distance from individuals, even if it means minor detours). For an “emergency stop,” strategies could include an “immediate brake” (applying maximum braking force) or a “controlled stop with warning” (decelerating rapidly while activating an audible alert).

Skill descriptor metadata associated with these eligible LLC strategies may be analyzed. For example, for a “dynamic obstacle avoidance” strategy, the metadata could include empirical data about observed historical performance, such as average deviation from path, proximity to obstacles, or instances of near-collisions. For an “immediate brake” strategy, metadata may include stopping distance at various speeds or the likelihood of an abrupt stop causing a secondary interaction with a nearby person or object.

Based on this analysis, one of the eligible LLC strategies is selected. For example, if the HLC output indicates “cautious traversal” due to high pedestrian density, and the empirical data for “dynamic obstacle avoidance” shows a low collision rate in similar conditions, that strategy might be chosen. If a sudden, unpredicted obstruction appears, triggering an “emergency stop” HLC, the “immediate brake” strategy may be selected if its historical data indicates the quickest stopping time with minimal secondary impact risks.

The visual representations and/or data derived therefrom may then be processed using LLC machine learning models associated with the selected strategy to generate LLC output, such as precise motor commands for the robot's wheels, steering mechanisms, and braking system to execute the chosen maneuver. This LLC output is used to generate a control signal for the robot, enabling it to navigate the crowded environment. The system can adapt in real-time by updating skill descriptor metadata based on observed historical performance, allowing the robot to refine its navigation strategies based on the flow and unpredictable movements of people in the terminal.

### BRIEF DESCRIPTION OF THE DRAWINGS

FIG. 1 is a schematic diagram of components that can cooperate to carry out selected aspects of the present disclosure.

FIG. 2 depicts a non-limiting example of a robot in the form of a robot arm.

FIGS. 3A and 3B depict an example in which a human player engages in a table tennis match with a robot configured with selected aspects of the present disclosure.

FIG. 4 schematically depicts an overview of how techniques may be implemented.

FIG. 5 schematically depicts one example of how a high-level controller may select from low-level controllers.

FIG. 6 depicts a flowchart depicting an example method for carrying out selected aspects of the present disclosure.

FIG. 7 is a block diagram of an example computing device that may optionally be utilized to perform one or more aspects of techniques described herein.

### DETAILED DESCRIPTION

Implementations are described herein for iteratively training repertoire(s) of low level control (LLC) strategies (alternatively, “skills” or “policies”) based on real world data. While various examples described herein will pertain specifically to real or simulated robots, this is not meant to be limiting. Techniques described herein may be more generally applicable to any embodied agent. As used herein, an embodied agent may refer to an intelligent system (e.g., software agent, robot, drone, etc.) that interacts with its real or virtual environment through a physical or virtual body. In addition to robots, embodied agents may include software-based agents configured to control a variety of different devices such as automated factory systems, home appliances, software-based agents that are designed to capture and subsequently perform repetitive workflows (e.g., on a personal computer), and many others.

In the robotics domain, as an embodied agent or robot 100 practices an LLC strategy, robot 100 gathers data that can be used to identify gaps or other shortcomings in the capabilities of robot 100. These gaps and/or shortcomings may then be addressed through continued training in simulation. This continuous improvement loop creates an automatic task curriculum, resulting in the LLC strategies improving over time. More particularly, but not exclusively, implementations are described herein for a hierarchical architecture for facilitating low latency performance of an embodied agent or robot 100 in a variety of different tasks. This hierarchical architecture may include a high level control (HLC) agent with a style selector policy (e.g., an HLC machine learning model) and a strategy framework for selecting a suitable LLC strategy from a plurality of “candidate” LLC strategies. In various implementations, the HLC agent may be configured to apply HLC machine learning model(s) to vision data captured by or on behalf of the embodied agent or robot 100 to generate output indicative of one or more selected high-level strategies or styles.

In some examples described herein, a robot may be configured to play a racket sport with opponent(s) such as other robot(s) or human(s). In such cases, the high level strategy or style may be, for instance, “forehand” versus “backhand.” In some such implementations, skill descriptors that might be associated with corresponding LLC strategies may include, for instance, initial ball position and/or velocity, hit velocity, ball landing location, and/or ball landing rate (e.g. how frequently a hit ball successfully bounces on an opponent's side of a court).

In other examples, the robot may be configured to leverage disclosed techniques to engage in other activities. For example, in some implementations, a robot may be configured to leverage techniques described herein for engaging in locomotion. For example, the HLC agent may process vision data indicative of the terrain and generate HLC output that identifies a gait style selected as suitable for the observed terrain, such as trot, long step, shuffle, tip toe, etc. In other implementations, the robot may leverage techniques described herein to engage in manipulation of object(s). For example, if a robot is to grasp an object, the HLC agent may generate HLC output that identifies a HLC style selected from, for instance, a plurality of grip styles of the robot. Additionally or alternatively, in some implementations, the HLC output may identify one or more target grasp points of one or more of the objects, such as the handle or body of a coffee mug, the edge of a plate, the handle of a tool, etc. In yet other implementations, techniques described herein may be used to control the robot to throw and/or catch an object. For example, the HLC agent may generate HLC output that identifies a throwing style such as overhand, underhand, side arm, a hard throw or a soft toss, etc.

In various implementations, these high-level strategies or styles may then be used, e.g., by the HLC agent, to narrow down or filter the list of candidate LLC strategies to a shortlist of what will be referred to herein as “eligible” LLC strategies. The HLC agent may then be configured to select a given LLC strategy from this short list of eligible LLC strategies using various techniques, such as heuristics, rules, decision trees, lookup tables, etc. For example, in some implementations, the plurality of LLC strategies may be associated with “skill descriptor metadata” that describes various aspects of the LLC strategies, such as empirical data about observed historical performance of LLC strategies under various different circumstances. In some implementations, the skill descriptor metadata may be indexed using a lookup table and/or tree (e.g., a k-dimensional tree, or “k-d tree”), which the HLC may leverage to select an LLC to be applied under the current circumstance.

In various implementations, each LLC may be associated with its own LLC machine learning model(s) that can be applied, e.g., by the HLC agent or by a separate LLC agent, to various data (e.g., images captured by a robot's vision sensor) to generate output indicative of robot control data. As used herein, “robot control data” may include, for instance, low-level actuator commands (also referred to as “joint commands,” and may include torque commands) that directly control the actuators/joints of the robot, cartesian commands that specify direction(s) for an end effector, a target robot pose, code that specifies reward functions that a motion controller can optimize (e.g., using techniques such as receding horizon optimization) to find optimal low-level actuator commands, selected predefined robot primitives, and so forth. In some cases, robot logic may be configured to convert between joint commands and Cartesian commands, e.g., using forward and/or inverse kinematics. This robot control data can then be used to operate one or more real and/or simulated robots.

To summarize, in various implementations, the HLC agent may apply one or more HLC machine learning models to vision data captured by or on behalf of a robot to generate output indicative of a high level style (“forehand” or “backhand” in the racket sport example). This high level style may then be used to narrow down a list of candidate LLC strategies to a shortlist of “eligible” LLC strategies. For example, each candidate LLC may be associated with a particular high level strategy, such as “forehand” or “backhand.” The HLC agent may then use skill descriptor metadata associated with the shortlist of eligible LLC strategies to select one of them for application. The selected LLC's corresponding LLC machine learning model(s) may then be applied to various data, such as the same vision data that was processed by the HLC agent using the HLC machine learning model(s) and/or additional data collected subsequently, to generate LLC output. The LLC output may include, or be usable to derive, robot control data. Robot control data can then be used to control a real or simulated robot.

The HLC and LLC machine learning models described herein may take a variety of forms. In some applications such as racket sports where latency is a priority, the HLC and/or LLC machine learning models may be, for instance, convolutional neural networks (CNNs) of various forms, such as dilated-gated CNNs, Residual Networks (ResNet), etc. In some implementations, these CNNs may also have and/or feed into one or more feature-wise linear modulation (FILM) layers. CNNs configured with selected aspects of the present disclosure may have various numbers of parameters, and in some cases, an HLC CNN may have fewer parameters than one or more of the LLC CNNs.

As one non-limiting example, an LLC machine learning model may take the form of a dilated-gated CNN having on the order of ten thousand parameters, whereas a corresponding HLC CNN may have fewer parameters, such as one thousand, two thousand, three thousand, four thousand, five thousand, six thousand, seven thousand, eight thousand, or nine thousand parameters, or any number of parameters in between, such as 1.5K parameters, 2.5K parameters, 3.5K parameters, 4.5K parameters, 5.5K parameters, 6.5K parameters, 7.5K parameters, 8.5K parameters, 9.5K parameters, etc. In other implementations, the HLC CNN may include other numbers of parameters, such as 1k-10k. 10k-20k, 20k-30k, 30k-40k, 40k-50k, and so on.

In other implementations, HLC and/or LLC machine learning models may take the form of various types of generative models, such multi-modal large language models (LLMs), vision language models (VLMs), diffusion models, and so forth. In some implementations, the HLC machine learning model may take the form of an HLC VLM that is trained and/or fine-tuned to, among other things, generate output indicative of a high level strategy or style, such as “forehand” or “backhand” in the racket sports context. Generative model(s) described herein may take various forms, including, but not limited to, model(s) such as PaLM, BERT, LaMDA, Meena, and/or any other generative model, such as any other generative model that is encoder-only based, decoder-only based, sequence-to-sequence based and that optionally includes an attention mechanism or other memory, diffusion model(s), etc. Generative models may have hundreds of millions, or even hundreds of billions of parameters. In some implementations, generative models may include multi-modal models such as a VLM and/or a visual question answering (VQA) model, which can have any of the aforementioned architectures, and which can be used to process multiple modalities of data, particularly images and text, and/or images and audio for example, to generate one or more modalities of output. Non-limiting examples of VLMs that may be applied as described herein include Gemini and/or Flamingo, to name a few. One non-limiting example of a VLM that might be used as the HLC generative model is described in “PaLM-E: An Embodied Multimodal Language Model” (arXiv:2303.03378), which is incorporated herein by reference.

Various techniques described herein can be configured to address diverse challenges. Certain architectures and training approaches described herein may be designed to address numerous challenges presented by competitive table tennis with humans. In some such implementations, a training task distribution may be implemented wherein the embodied agent is configured to successfully handle balls that amateur human table tennis players are likely to play when interacting with the robot. Specifically, this means that for every ball an opponent hits towards the robot, the robot is configured to hit the ball such that it bounces on the opponent's side of the table.

Multiple skills and multiple levels of decision-making are contemplated. Playing table tennis (or any racquet-based sport) can require simultaneous strategic decision-making, such as where and how to return a ball, how much risk to assume, or how much to explore to probe for opponent weak spots. It can also require execution of multiple low-level skills, such as a forchand lob, a backhand topspin, or a forehand cross-court smash. The robot may be configured to interact with a human to complete the task. A robot table tennis agent configured with selected aspects of the present disclosure may be configured to adapt during a match to reduce the risk of its weak spots being exploited. Table tennis balls commonly have a velocity of 5 m/s or more. This characteristic can require high-frequency control and can impose strong constraints on inference time, such as 3-5 ms.

In some examples, a robot configured to play table tennis may take the form of a six Degree of Freedom (DoF) arm mounted on two linear gantries, enabling motion in a 2D plane. The X gantry, configured to move side-to-side across a table, may have various lengths, such as four meters. The Y gantry, configured to move towards and away from the table, may have various lengths, e.g., such as two meters. In some implementations, a 3D-printed paddle handle and a paddle with pips rubber may be attached to the arm. One or more digital cameras, e.g., operating at various frequencies such as 60 Hz to 240 Hz, or even higher, e.g., 500 Hz, may be configured to capture images of a ball. These captured images may be utilized as input into a neural-perception system, which generates ball positions at the same frequency. A motion capture system, which may include one or more cameras mounted around a play area, may be configured to track the human opponent's paddle.

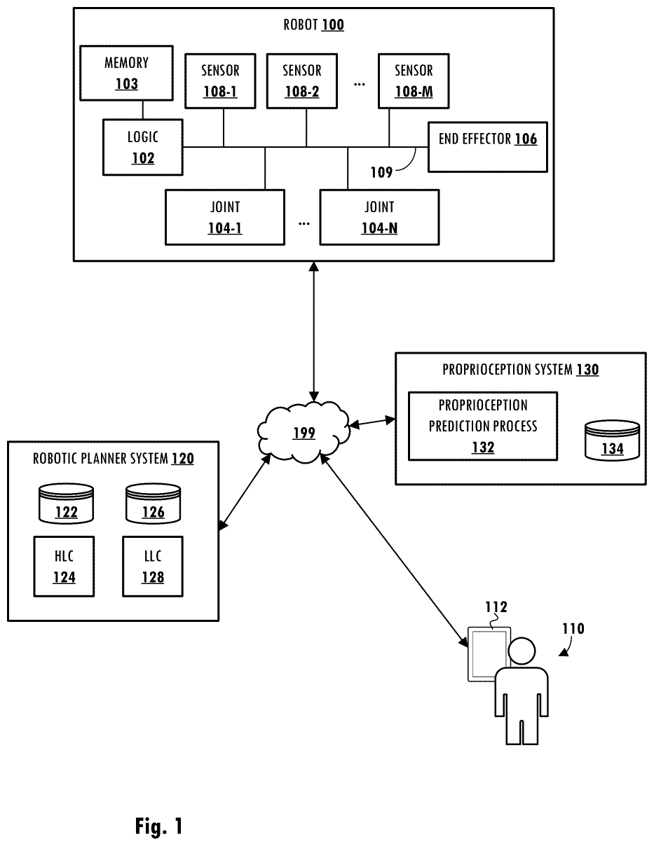

FIG. 1 is a schematic diagram of components that can cooperate to carry out selected aspects of the present disclosure, in accordance with various implementations. The various components depicted in FIG. 1, particularly those components forming a robotic planner system 120 and a proprioception system 130, may be implemented using any combination of hardware and software. The components of FIG. 1 are depicted as being communicatively coupled with each other via one or more networks 199, which may include one or more personal area networks, local area networks, and/or wide area networks (e.g., the Internet). However, this is not meant to be limiting. Various aspects of the present disclosure that are described as being performed by and/or stored on systems 120 and/or 130 can alternatively be performed by and/or stored on a single system, such as robot planner system 120, or on any combinations of systems 120 and 130.

In some implementations, techniques described herein may be used to control various types of machines or apparatus. For example, in some implementations, a robot 100 may be in communication with systems 120 and/or 130. In various implementations, and/or all or parts of systems 120 and/or 130 may be implemented onboard robot 100. Other types of machines or apparatus that are not depicted in FIG. 1 may also be controlled using selected aspects of the present disclosure, such as autonomous vehicles, industrial equipment, climate control systems, medical systems and/or devices, video games, and so forth.

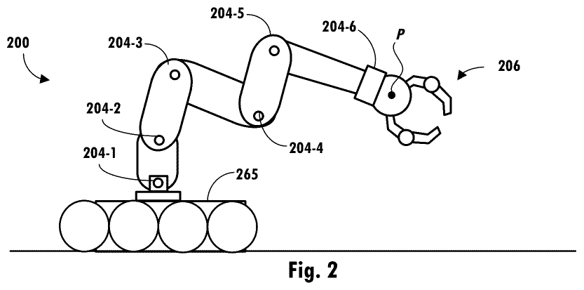

Robot 100 may take various forms, including but not limited to a telepresence robot (e.g., which may be as simple as a wheeled vehicle equipped with a display and a camera), a robot arm, a multi-pedal robot such as a “robot dog,” an aquatic robot, a wheeled device, a submersible vehicle, an unmanned aerial vehicle (“UAV”), and so forth. One non-limiting example of a mobile robot arm is depicted in FIG. 2. In various implementations, robot 100 may include logic 102. Logic 102 may take various forms, such as a real time controller, one or more processors, one or more field-programmable gate arrays (“FPGA”), one or more application-specific integrated circuits (“ASIC”), and so forth. In some implementations, logic 102 may be operably coupled with memory 103. Memory 103 may take various forms, such as random-access memory (“RAM”), dynamic RAM (“DRAM”), read-only memory (“ROM”), Magnetoresistive RAM (“MRAM”), resistive RAM (“RRAM”), NAND flash memory, and so forth. In some implementations, a robot controller may include, for instance, logic 102 and memory 103 of robot 100.

In some implementations, logic 102 may be operably coupled with one or more joints 104-1 to 104-N, one or more end effectors 106, and/or one or more sensors 108-1 to 108-M, e.g., via one or more buses 109. As used herein, “joint” 104 of a robot may broadly refer to actuators, motors (e.g., servo motors), shafts, gear trains, pumps (e.g., air or liquid), pistons, drives, propellers, flaps, rotors, or other components that may create and/or undergo propulsion, rotation, and/or motion. Some joints 104 may be independently controllable, although this is not required. In some instances, the more joints robot 100 has, the more degrees of freedom of movement it may have.

As used herein, “end effector” 106 may refer to a variety of tools that may be operated by robot 100 in order to accomplish various tasks. For example, some robots may be equipped with an end effector 106 that takes the form of a claw with two opposing “fingers” or “digits.” Such a claw is one type of “gripper” known as an “impactive” gripper. Other types of grippers may include but are not limited to “ingressive” (e.g., physically penetrating an object using pins, needles, etc.), “astrictive” (e.g., using suction or vacuum to pick up an object), or “contigutive” (e.g., using surface tension, freezing or adhesive to pick up object). More generally, other types of end effectors may include but are not limited to drills, brushes, force-torque sensors, cutting tools, deburring tools, welding torches, containers, trays, and so forth. In some implementations, end effector 106 may be removable, and various types of modular end effectors may be installed onto robot 100, depending on the circumstances. Some robots, such as some telepresence robots, may not be equipped with end effectors. Instead, some telepresence robots may include displays to render visual representations of the users controlling the telepresence robots, as well as speakers and/or microphones that facilitate the telepresence robot “acting” like the user.

Sensors 108-1 to 108-M may take various forms, including but not limited to 3D laser scanners (e.g., light detection and ranging, or “LIDAR”) or other 3D vision sensors (e.g., stereographic cameras used to perform stereo visual odometry) configured to provide depth measurements, two-dimensional cameras (e.g., RGB, infrared), light sensors (e.g., passive infrared), force sensors, pressure sensors, pressure wave sensors (e.g., microphones), proximity sensors (also referred to as “distance sensors”), depth sensors, torque sensors, barcode readers, radio frequency identification (“RFID”) readers, radars, range finders, accelerometers, gyroscopes, compasses, position coordinate sensors (e.g., global positioning system, or “GPS”), speedometers, edge detectors, Geiger counters, and so forth. While sensors 108-1 to 108-M are depicted as being integral with robot 100, this is not meant to be limiting.

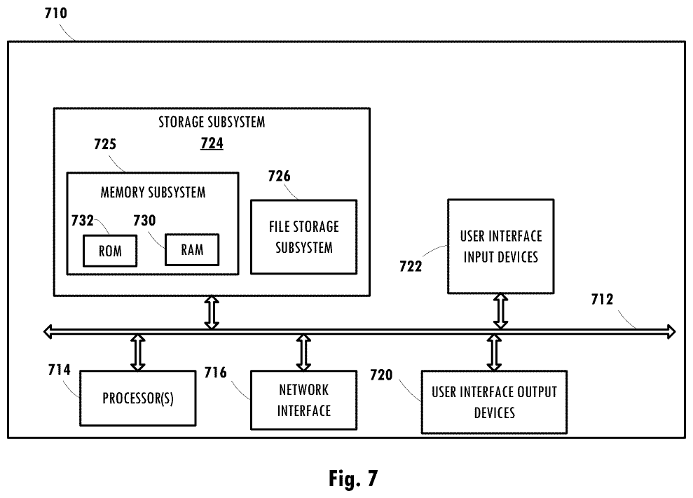

In some implementations, robot planner system 120 and/or proprioception system 130 may include one or more computing devices cooperating to perform selected aspects of the present disclosure. An example of such a computing device is depicted schematically in FIG. 7. In some implementations, one or more of systems 120 and/or 130 may include one or more servers forming part of what is often referred to as a “cloud” infrastructure, or simply “the cloud.” Alternatively, one or more components of systems 120 and/or 130 may be operated by logic 102 of robot 100.

Machine learning and/or generative model(s) described herein may take various forms, including, but not limited to, generative model(s) such as Pathways Language Model (PaLM), Unified language Model (ULM), PaLM-2-E/ULM-E, BERT, LaMDA, Meena, and/or any other generative model, such as diffusion model(s), flow models, any other generative model that is encoder-only based, decoder-only based, sequence-to-sequence based and that optionally includes an attention mechanism or other memory, etc. Generative models and/or diffusion models may have hundreds of millions, or even hundreds of billions of parameters. In some implementations, generative and/or diffusion models may include multi-modal models such as a VLM and/or a visual question answering (VQA) model, which can have any of the aforementioned architectures, and which can be used to process multiple modalities of data, particularly images and text, and/or images and audio for example, to generate one or more modalities of output. Non-limiting examples of VLMs that may be applied as described herein include Gemini and/or Flamingo, to name a few. Another example of a generative model that might be used is described in “RT-2: Vision-Language-Action Models Transfer Web Knowledge to Robotic Control” (arXiv: 2307.15818), which is incorporated herein for all purposes.

Robot planner system 120 may include a high level controller (HLC) 124 with access to one or more HLC machine learning models 122, and a low level controller (LLC) 128 with access to one or more LLC machine learning models 126. Any of controllers 124 or 126 may be implemented using any combination of hardware and software. Moreover, controllers 124 and 126 may be combined with each other and/or other components.

In various implementations, HLC 124 may be configured to orchestrate low-level skills by processing one or more visual representations, such as digital images from a digital camera or point cloud data from a LIDAR sensor, to generate HLC output. Additionally or alternatively, HLC 124 may be configured to process data derived from the visual representations to generate HLC output. For example, HLC 124 can process visual representations depicting an incoming ball in a racket sport, or derived data indicating position(s) and/or velocity of the ball, to identify a HLC style comprising a forehand or a backhand, or process visual data indicative of terrain for locomotion to identify a gait style such as trot or shuffle. HLC 124 may also identify a HLC style selected from a plurality of grip styles for object manipulation, or identify target grasp points for an object.

In some implementations, HLC 124 may be configured to analyze skill descriptor metadata, which can include empirical data about observed historical performance of various LLC strategies, possibly stored in a lookup table or a lookup tree. This analysis, potentially combined with empirical data about a co-participant, such as a human or another embodied agent, and preferences represented as a q-value, allows HLC 124 to select one of two or more eligible LLC strategies.

In some implementations, HLC 124 can operate in an event-driven manner, making decisions once per shot in dynamic activities like table tennis. For instance, its control flow may occur within a time interval such as 20 milliseconds to accommodate high-frequency control requirements.

As will be described in more detail below, in some implementations, HLC 124 may incorporate a style policy, a spin classifier, and utilize match strategies and LLC H-values to refine its selection process and adapt to novel opponents in real-time. In this context, H-values are learned numerical preferences associated with each LLC strategy, which are updated dynamically based on an LLC's observed performance during a match. These values serve to adapt the HLC agent's strategy in real-time to the specific characteristics and performance of an opponent. In various implementations, HLC 124 may utilize one or more HLC machine learning models 122, which can include a convolutional neural network (CNN), such as a dilated-gated CNN, or a generative model such as a vision language model (VLM).

An LLC 128 may be configured to generate robot control data based on various modalities of data. Each LLC 128 may use one or more LLC machine learning models associated with a selected eligible LLC 128 to process visual representation(s) of an environment in which an embodied agent engages in an activity, and/or to process data derived from those visual representations, such as ball position(s) and/or velocity. LLC machine learning models 126 can be tailored for distinct table tennis capabilities, for example, for a forchand style while striking cross-court balls, for a conservative backhand play, or for returning underspin serves using a forchand style. Each LLC 128 may be configured to produce joint velocity commands at various rates, such as 50 Hz, thereby enabling low-level actuator commands, Cartesian commands, or target robot poses. In various implementations, there may be multiple LLCs 128, and each can specialize in a specific aspect of a task, such as consistent returns, faster returns, targeting specific parts of a table, or returning particular types of balls. Multiple, modular LLCs 128 may be employed, allowing for extensibility, avoiding catastrophic forgetting of acquired skills, and facilitating efficient evaluation, as each modular LLC 128 generally requires relatively little time for inference, for example, on the order of one millisecond. In some implementations, LLC 128 may utilize one or more LLC machine learning models 126, which can include a convolutional neural network (CNN), such as a dilated-gated CNN. The selection of a specific LLC 128 for execution can be determined by HLC 124 during each incoming ball episode, with the LLC output being usable to derive robot control data for operating a real or simulated robot.

Proprioception system 130 may be present in some implementations where robot 100 is being controlled using techniques described herein. Proprioception system 130 may be omitted in other circumstances. Proprioception system 130 may include a proprioception prediction process 132 and one or more proprioception machine learning models 134. Examples of proprioception machine learning models 134 that may be used are described in “RT-1: Robotics Transformer for Real-World Control at Scale” (arXiv:2212.06817), which is incorporated herein for all purposes, and the aforementioned RT-2 paper.

In various implementations, proprioception prediction process 132 may process input tokens indicative of a current (or past) proprioception values of robot 100, e.g., along with other data such as data indicative of a task or action to be performed, state data of the robot and/or its environment, and/or actions predicted by robotic planner system 120, to generate robot control data and/or predict future proprioception values of robot 100. These robot control data and/or future proprioception values may be used to operate robot 100. In instances where robotic planner system 120 generates actions expressed in natural language, proprioception prediction process 132 may use proprioception machine learning model(s) 134 to translate these actions expressed in natural language into robot control data.

In other implementations, generative model(s) used by robotic planner system 120 may be trained or fine-tuned to directly generate robot control data and/or future proprioception values, in which case proprioception system 130 may be omitted. For example, in some implementations, LLC 128 of robotic planner system 120 may be configured to process various modalities of data using various types of machine learning models to generate robot control data directly.

“Robot control data” may include, for instance, low-level actuator commands (also referred to as “joint commands,” and may include torque commands) that directly control the actuators/joints 104-1 to 104-N of the robot, cartesian commands that specify direction(s) for an end effector 106, a target robot pose, code that specifies reward functions that a motion controller can optimize (e.g., using techniques such as receding horizon optimization) to find optimal low-level actuator commands, selected predefined robot primitives, and so forth. In some cases, robot logic 102 may be configured to convert between joint commands and Cartesian commands, e.g., using forward and/or inverse kinematics.

In various implementations, a user 110 may control robot 100 using a client device 112. While depicted as a tablet computer or smartphone in FIG. 1, client device 112 may take other forms, such as a desktop or laptop computer, in-vehicle computing device, augmented reality (AR) and/or virtual reality (VR) headset or glasses, standalone “smart” speakers that host automated assistants that can be interacted with the control robot 100, etc. In various implementations, user 110 may issue one or more natural language commands, e.g., by typing the commands or uttering the commands aloud and having those spoken utterances transcribed using speech-to-text (STT) processing. These natural language commands may specify a task to be completed by robot 100 in an environment in which robot 100 operates. For example, user 110 may ask robot 100 to “pick plate from top drawer and place on counter, and close drawer,” “close the windows,” “take the dishes from the table to the sink,” etc.

FIG. 2 depicts a non-limiting example of a robot 200 in the form of a robot arm. An end effector 206 in the form of a gripper claw is removably attached to a sixth joint 204-6 of robot 200. In this example, six joints 204-1 to 204-6 are indicated. However, this is not meant to be limiting, and robots may have any number of joints. In some implementations, robot 200 may be mobile, e.g., by virtue of a wheeled base 255 or other locomotive mechanism. Robot 200 is depicted in FIG. 2 in a particular selected configuration or “pose.”

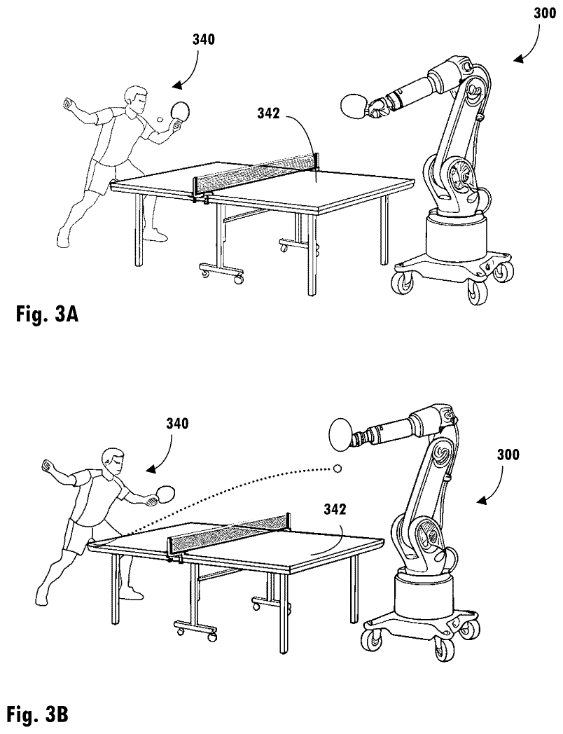

FIGS. 3A and 3B depict an example in which a human player 340 engages in a table tennis match with a robot 300 configured with selected aspects of the present disclosure. In FIG. 3A, player 340 has tossed the table tennis ball in the air and is prepared to serve. Robot 300 stands at the ready holding a paddle. In FIG. 3B, player 340 has served the table tennis ball towards robot 300, which is maneuvering to return the serve.

Table tennis may be modeled as a single-agent sequential decision-making problem in which a human opponent is modeled as part of the environment. A Markov Decision Process (MDP) formalism may be used, for instance. In some implementations, a MDP may be formulated as a four-tuple, the elements of which include a state space, an action space, a reward function, and transition dynamics. An episode may be defined as a finite sequence of states, actions, and reward elements, commencing with a starting state and terminating when the environment ends. An episode may include a single ball hit and return, beginning at the moment an opponent's paddle contacts a ball and concluding when the robot (1) returns the ball, (2) the ball moves out of play, or (3) the robot fails to hit the ball. A ball return signifies that the robot hits the ball such that it bounces on the opponent's side of the table without first bouncing on the robot's side.

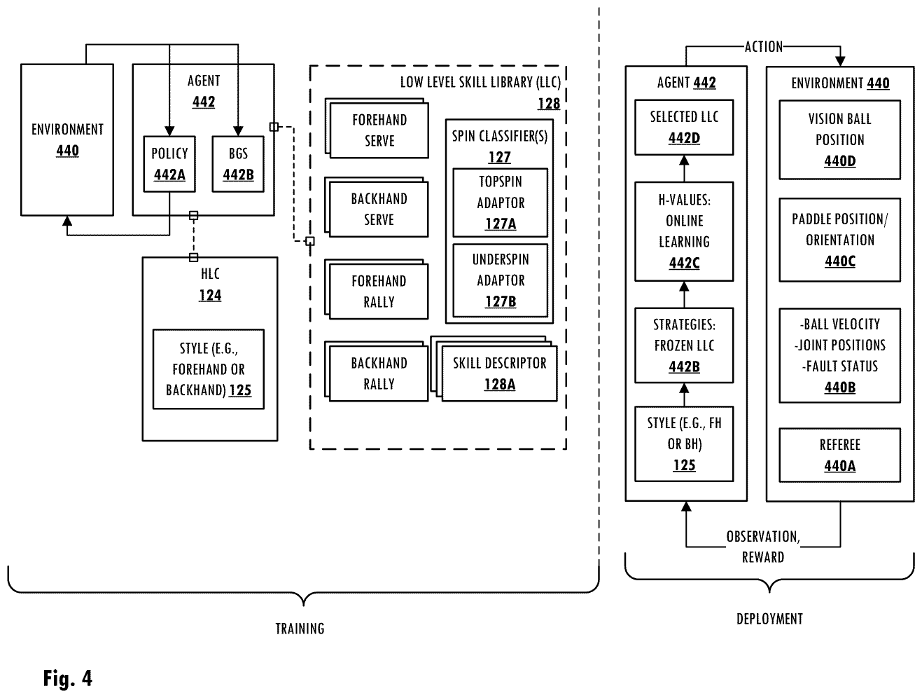

Some environments in which various implementations described herein are deployed may include a neural-perception system configured to track a ball, a motion capture system configured to track a human player's paddle pose, a software “referee” (440A in FIG. 4) configured to track a state of a game, and an observation module configured to provide data, such as ball position and velocity, or robot position, to a policy. In some cases there may be a corresponding simulated environment built upon various types of physics engines.

FIG. 4 schematically depicts an overview of how techniques may be implemented, in accordance with various implementations. While various components are depicted separately in FIG. 4, this is not meant to be limiting. In various implementations, two or more of the components depicted in FIG. 4 may be combined. The components depicted in FIG. 4 may be implemented using software and/or hardware.

The table tennis agent, as illustrated in FIG. 4, operates with two levels of control: a high-level controller (HLC) 124 and a plurality of low-level controllers (LLCs) 128. Each LLC can be a policy configured to generate joint velocity commands at various rates, such as 25-75 Hz, 50 Hz, etc. Each LLC may possess distinct table tennis capabilities. For example, a particular LLC may be configured for a forehand style while striking cross-court balls, another for a conservative backhand play, and another specialized for returning underspin serves using a forchand style.

HLC 124 may be configured to select a specific LLC 128 for execution during each incoming ball episode. HLC 124 does not necessarily operate at a fixed control frequency. In some implementations, HLC 124 makes event-driven decisions, triggered to act each time an opponent strikes the ball, e.g., once per shot. HLC 124 may have access to various components that cooperate to determine the selection of an LLC 128: (1) a style policy 125, configured to choose between a forehand or backhand play-style based on the incoming ball; (2) a spin classifier(s) 127, which provide information regarding the spin of the incoming ball, e.g., topspin (127A) or underspin (127B); and (3) LLC skill descriptors 128A, which furnish performance metadata for each LLC, such as an estimated return rate, a ball hit velocity, and a land position. This metadata is conditioned on the characteristics of the incoming ball; (4) match strategies, which incorporate information concerning the opponent's and the robot's performance; (5) a strategies component, which receives inputs from the style policy, the LLC skill descriptors, and the match strategies, and generates a shortlist of LLCs; and (6) LLC H-values 442C, which provide an estimate of the performance of each LLC for a current player and are updated following each shot. The HLC combines information from the LLC skill descriptors 128A, the strategies component 442B, and the LLC H-values 442C to produce a final selection of an LLC 442D. The entire control flow within the HLC 124 may occur at various frequencies, such as within a duration of 20 milliseconds.

The hierarchical architecture of the table tennis agent depicted in FIG. 4 is motivated by the inherent requirement for multiple skills and multiple levels of decision-making in table tennis. Similar to the learning process observed in human players, the development process emphasizes first establishing capabilities in individual skills, represented by the LLCs 128, before proceeding to the higher-level strategic aspects of the game, managed by HLC 124.

The system's utilization of multiple, modular LLCs 128A-D in place of a single monolithic LLC 128 provides various technical benefits. One technical benefit is avoiding forgetting: once a robust skill has been acquired, it remains preserved, and can additionally serve as an initialization point for the acquisition of further skills. Another technical benefit relates to extensibility: incorporating new skills is straightforward, requiring only the addition of a new LLC 128. A further technical benefit is evaluation efficiency, which in turn accelerates the pace of experimentation. Once an LLC has been validated in a real-world environment, its capabilities are well understood and generally do not necessitate re-testing. In contrast, a monolithic learned system would typically require re-testing across its full suite of expected capabilities each time its model weights are modified. A further technical benefit relates to fast inference: the inference process for each modular LLC 128A, 128B, 128C, 128D generally requires relatively little time, e.g., on the order of one millisecond.

In some implementations, the HLC policy and the LLC policies 128A-D may be trained iteratively, alternating between simulated training and zero-shot deployment in the real world during which human opponents play with the robot. To excel in interactive sports, it is beneficial to understand both one's own capabilities and those of the opponent. This motivated the development of LLC skill descriptors 128A, which model the robot's capabilities in detail, and the tracking of match statistics and LLC H-values 442C, which provide a rudimentary model of the human opponent.

Finally, the fact that humans are unpredictable and learn fast motivated the real-time adaptation of the HLC, i.e. updating LLC H-values 442C based on real-time data during a match. This enabled agent 442 to refine its decision making in order to adapt to novel opponents.

The simulation of robotic table tennis involves two primary challenges. The first challenge is accurately modeling the dynamics of the robot, paddle, and ball. A high degree of fidelity is necessary because advanced table tennis play requires the manipulation of ball angular velocity, also known as spin. Additionally, due to the diminutive size and light weight of the ball, elements such as air friction and paddle material significantly influence the dynamics to a greater extent than in conventional robotic tasks. The second challenge pertains to precisely modeling the task distribution, which refers to the distribution of initial states of real-world incoming ball trajectories directed toward the robotic player.

In contrast to previously described approaches, the enhanced simulation components described in this section enabled a high degree of zero-shot transfer, thereby eliminating the need for real-world fine-tuning of low-level policies.

Turning first to modeling ball and robot dynamics, a simulation environment may be enhanced through the incorporation of a physics engine, leveraging its advanced solid-state fluid dynamics for ball trajectory simulation. This enhancement may include refining existing models and performing system identification, as well as improving the representation of paddle rubber characteristics.

In some implementations, the simulation may use integrated-velocity actuators. These actuators may be stateful and include an activation state coupled with an integrator and a position-feedback mechanism. The activation state may correspond to a setpoint for the position of an actuator, and the control signal may represent the velocity of this setpoint. System identification may be performed for each actuator-joint pair to determine parameters such as position gain, actuator damping, friction loss, joint damping, force limits, and armature inertia, to name a few.

In some implementations, the physics engine's ellipsoid-based stateless fluid model may be utilized for simulating ball trajectories. A Blunt drag coefficient may be measured, and a default value may be applied for a Slender drag coefficient, while an Angular drag coefficient may be set to zero. The Kutta lift coefficient and Magnus lift coefficient may be kept at their default values in some cases.

In some implementations, the paddle rubber may be modeled using two orthogonal passive joints representing a spring-damper system to approximate a rubber surface. Ball-rubber contact solver parameters (e.g., softness, slip, friction) may be determined empirically, while joint stiffness, damping, and armature may be established through parameter sweeps optimizing for sim-to-real transfer. Analogously, ball-table contact solver parameters may also be measured and used.

A bimodal distribution has been observed in the paddle rubber solver parameter space for topspin and underspin ball contact. Consequently, during the topspin correction phase of policy training, the simulator may be configured to dynamically select appropriate solver parameters based on the ball's pre-contact spin.

In addition to modeling observation noise and latency, in some implementations, table and paddle damping and friction parameters may be randomized during training. A net height reward and a target for the last ABB joint at ball-paddle contact may be introduced to incentivize competitive returns and minimize overshooting.

Turning next to spin “correction” and sim-to-real adapter layers, the paddle rubber physical parameters in simulation may exhibit a bimodal characteristic, depending on whether an incoming ball possesses topspin or underspin. In fact, deploying the policy trained revealed a significant sim-to-real gap for topspin balls. Various techniques may mitigate this issue, such as topspin correction and sim-to-real adapter layers.

For topspin correction, the base policy may be fine-tuned to switch to topspin-related paddle parameters when an incoming ball has topspin. A net height reward may also be incorporated, requiring a returned ball to cross a net at a certain height, and a target joint angle may be set for ball contact. These technique successfully when implemented closed the sim-to-real gap in many specialized skills and increased the speed of robot returns, providing a technical advantage. However, this approach alone was insufficient to close the sim-to-real gap observed in generalized skilled policies for 80% of the maximum topspin that an opponent's paddle can produce.

To address the remaining gap, the topspin-corrected policy may be augmented with a thin feature-wise linear modulation (FILM) layer. This adapter may be trained without underspin balls. The FILM layer maps an original action to a modified action by applying a scaling factor and a bias. Specifically, given an original action, the FILM layer learns a function that outputs the scaling factor and the bias, which are then used to linearly transform the original action. In some (but not all) implementations, the FILM layer may include, for instance, 2.8K parameters, and the adapter may be trained for 5k steps. When this FILM layer was implemented, the sim-to-real gap was closed while underspin return ability was preserved. Similar techniques may be applied to heavy underspin and side spins.

In some implementations, real data may be used to initialize simulated ball trajectories. A seed dataset that includes some time interval (e.g., 40 minutes) of human vs. human play may be collected, along with some number (e.g., hundreds, thousands) varied ball throws from a ball thrower. A perception system may be utilized to extract ball positions at various frequencies. including but not limited to 125 Hz. The sequence of ball positions may be segmented into trajectories of single ball hits where the first ball position of a trajectory is when the ball enters play or immediately after a hit. An offline optimization process may be employed to extract an initial ball state—e.g., position, velocity, and angular velocity—from each trajectory. This extraction may be performed such that a simulated ball trajectory starting at that state closely matched a real ball trajectory. The output of this process may include a dataset of initial ball states.

In practice, initial data collection yielded 2.6k initial ball states. Services were initially excluded because they constitute a small portion of a table tennis game compared to rallies, and their exclusion simplified training. An independent initial serving dataset of 0.9k balls was gathered separately. For serving trajectories, a least-squares optimization method, which utilized robust loss functions, was employed in the offline optimization.

Policies were trained in simulation with the objective of returning all balls within the dataset. During simulated training, a ball state was sampled from the dataset, small random perturbations were added, and the resulting trajectory was validated. Subsequently, the internal state of the physics engine was initialized with the ball state, and an episode was commenced. Given that the hardware setup does not estimate angular velocity, the angular ball state extracted from trajectories is accurate only in a least-squares sense.

The non-parametric approach to generating initial ball states, involving direct sampling from the dataset, proved to be substantially more effective than prior approaches, some of which utilized a uniform initial ball state distribution, with its bounds derived from real ball trajectories. The direct sampling approach described herein improves sim-to-real transfer by more closely aligning the training distribution with ball trajectories typically generated by human players. Position and velocity components are interrelated. For example, a ball with high linear y velocity is unlikely to have a high positive linear z velocity, nor is it likely to have high backspin. Consequently, independent sampling of different dimensions can generate ball states that are unrealistic in the real world or are not typically played by amateur human players. Direct sampling preserves empirical interrelationships among different dimensions of the ball state. Additionally, since training cycles were not expended on unrealistic ball states, model capacity was utilized more effectively, resulting in faster training and higher return rates for a given model architecture and training algorithm.

A system configured with selected aspects of the present disclosure was then deployed in a real-world environment and evaluated against human opponents. Following the same process previously outlined, all evaluations were converted into another dataset of initial ball states. Each entry in this dataset was automatically annotated by a software ‘referee’ 440A with one of the following outcomes: “return” (indicating the ball was successfully returned), “hit” (indicating the paddle made contact with the ball but it did not land on the opponent's side), or “miss ball” (indicating the paddle did not touch the ball). This new dataset was then appended to the initial dataset. Ball trajectories that were not returned (those annotated as “hit” or “miss”) could optionally be overweighted in subsequent training cycles.

This iterative cycle involved training models in simulation using the latest dataset, evaluating those models in the real world, and then using the results of those evaluations to extend the dataset.

On technical benefit of the iterative approaches described herein is that if the policy is repeatedly evaluated against diverse opponents, gaps in capabilities may be automatically identified and filled. As the agent's skills improve, new weaknesses may be revealed whilst simultaneously generating training data to address them. During implementation, it was observed that after seven cycles performance had not plateaued, suggesting that further cycles could have continued to yield performance improvements.

Two further modifications to the training data distribution may be beneficial for boosting performance: (1) reflecting the data along the y axis may help to correct a bias towards forchand play and may double the final dataset size, e.g., from 14k ball states to 28k ball states; and (2) manually segmenting the dataset into seven non-mutually exclusive categories-Fast, Normal speed, Slow, Topspin, No spin, Underspin, Lob—may also be configured. During training, balls may be selected each episode by first sampling a category with a probability inversely proportional to the return rate of all balls within that category and then an initial ball state may be sampled random uniformly from within that category. This approach may allow for a focus on weak categories while still maintaining performance on “easier” balls within those categories and across all categories.

Implementations described herein may be deployed on hardware in various ways. Policies may be trained in simulation to return individual incoming balls, substantially simplifying training. To adapt these policies to play a full game of table tennis, each point may be divided into sub-episodes that mimic the training against individual balls: they may start when the opponent's paddle contacts the ball and end when the robot returns the ball or a point is scored by either player (i.e., the ball leaves play). After a sub-episode, the robot and internal data structures of the real environment may be reset, ensuring that the policy experienced the single-episode semantics it saw in simulation. This step may prove beneficial for achieving high sim-to-real zero-shot transfer. To estimate paddle state, a customized paddle equipped with motion capture capabilities may be employed.

LLC policies 126 provide a library of skills that HLC 124 may deploy in its strategies. An approach to training LLC policies 126 can be summarized in three steps: (1) two generalist base policies may be trained, one for each main play style (forehand, backhand) and may be added to the set of LLC policies 126; (2) LLC policies 126 may be specialized to different skills by adding reward function components and/or adjusting the training data mix before fine-tuning a new policy initialized from one of the existing LLCs (this is typically one of the generalist base policies but could be any policy in the LLC set); and (3) new LLC policies 126 may be evaluated. For example, if an LLC policy 126 is trained to target a particular location on the table, the average error between the ball landing position and target may be calculated. If successful, the new LLC policy 126 may be added to the set of LLC policies 126.

In some implementations, LLC policies 126 may be trained in simulation with blackbox gradient sensing, an evolutionary strategies method algorithm. It has been observed that BGS policies may produce relatively smooth actions, whereas policies trained with reinforcement learning (RL) algorithms may produce noticeably jerkier actions. Additionally, BGS-trained policies have been observed to have strong sim-to-real transfer performance. It is hypothesized that action smoothness and potentially less overfitting to the simulator may be the main reasons why BGS-trained policies exhibit such good transfer.

As noted previously, in various implementations, a policy architecture may include a dilated-gated CNN that follows a particular architecture and may include, for instance, 10,000 parameters. An optional FiLM adapter layer may be included and may be configured to aid sim-to-real transfer. The CNN may contain 1D convolutions, which may convolve across timesteps. This may accelerate learning and may lead to smoother outputs. The observation space may be a matrix of various dimensions, including but not limited to 8×16. This observation space may include some number (e.g., eight) of timesteps of ball position and velocity, a robot joint position, and a one-hot style component (forehand or backhand). The observation space may correspond to ball states observed at a particular time t, which may be defined by an array including the x, y, and z coordinates of the ball, the x, y, and z components of the ball's velocity, the x, y, and z coordinates of linear gantries, and the alpha angles corresponding to the robot arm's joints, along with style components. The style component may be removable without affecting performance. All policies may output actions with a dimension of eight, representing joint velocities at frequencies such as 500 Hz. Eight timesteps may correspond to 0.16 seconds of history, which may be empirically determined to be sufficient to smooth out noise in the trajectory and to provide context to the current state.

To train for a particular style, such as forchand or backhand, each ball state in the dataset may be annotated with forehand, backhand, or center. This annotation may be based on where the ball trajectory may intersect with the back of the table on the robot side. Center may be defined as within +/−0.2 m around the center of the table, forehand as greater than 0.2 m, and backhand as less than −0.2 m. Forchand policies may be trained on only forehand and center balls, and backhand policies may be trained on backhand and center balls. This may create an overlap in the center where policies of either style may be capable of returning the same balls. The policy may also be rewarded for moving towards a reference pose (either forehand or backhand) at the beginning of the shot. Without such a reward, the robot may sometimes employ a backhand pose to hit forehand balls even if it is less efficient. These base policies may be beneficial, not only to provide strong starting policies capable of returning a wide range of balls for specialization, but also to anchor play in specific styles for efficient returns.

Specialist training may be performed for various skills based on advice from a table tennis coach and general game intuition. These skills may include targeting specific return locations, maximizing return velocity, and specializing to return serves that may either exhibit topspin or backspin, fast balls, and lobs. It was determined that a specialist to handle lobs may not be needed, and a specialist on fast balls could not be trained due to data limitations and hardware constraints. Therefore, focus was placed on developing serving, targeting, and fast hitting specialists in addition to the generalists.

In some cases, the system may include seventeen LLCs. Of these, four may be specialized for returning serves, and thirteen for rallying. Eleven may play with a forchand style, and six with a backhand style. Each policy may have the same initial robot pose, which may enable straightforward sequencing of LLC choices, since the initial robot pose may be in-distribution for all LLCs.

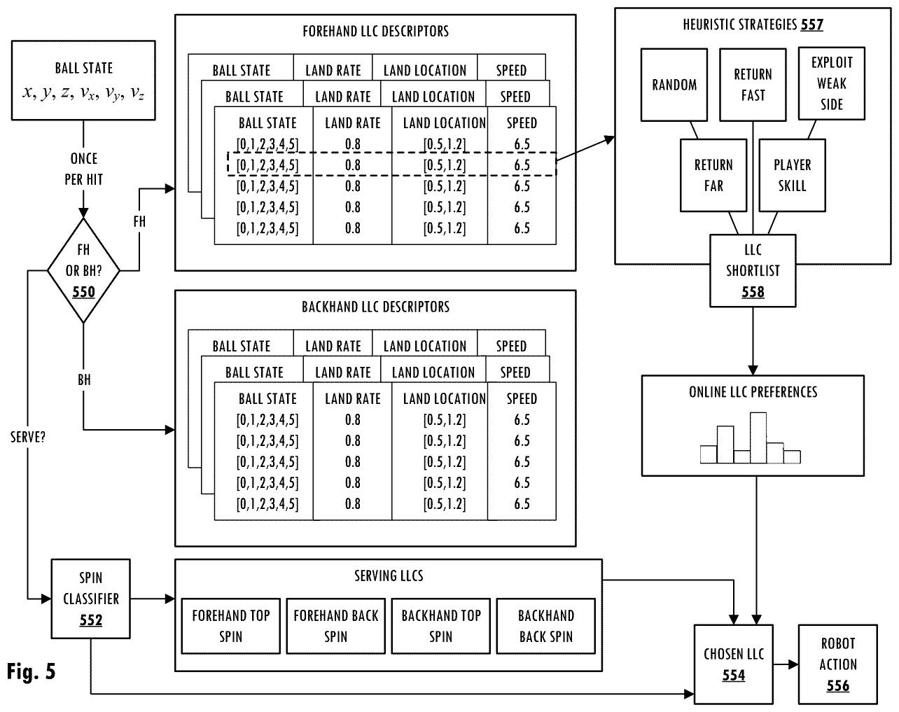

FIG. 5 schematically depicts one example of how HLC 124 may select from LLCs 128, in accordance with various implementations. As noted previously, HLC 124 may be responsible for making strategic decisions—e.g., where to return the ball, how fast to hit, how much risk to take.

In some implementations, an HLC action may be triggered by an opponent hitting a ball, which may be an event external to the agent. One timestep after the opponent hits the ball, HLC 124 may make a strategy decision that applies until the opponent hits the ball again. Until HLC 124 decides on the strategy for that ball, the robot (e.g., 100, 300) may not move. Waiting one step may provide the policy with sufficient information to make a strategic decision; other numbers of steps, such as zero and three steps, were also considered, but three steps did not provide the robot with sufficient time to react to faster balls, and zero steps did not allow for good estimation of ball velocity. The strategic decision may be made only once because it was determined that switching LLCs 128 mid-swing may result in the policies ending up in states that were out of their training distribution, which may include the robot arm being not where it was expected to be because the previous LLC moved it somewhere new.

The style policy may determines whether the ball should be returned with a forchand or backhand style. A naive heuristic may be to simply divide the table in half and select a style based on which half the ball is predicted to land on based on rolling physics forward. However, such an approach may neglect various strategic tradeoffs, such as forchand shots being easier to smash and the ambiguous nature of balls near the center. Additionally, real-world noise and an inability to fully capture spin may indicate that physics estimates are inaccurate. By learning a style policy, HLC 124 may comprehend the strengths of individual LLCs 128 and compensate for systematic inaccuracies, which may lead to better overall strategic decisions.

The style policy architecture, which may be similar to that of an LLC 128 but with different numbers of parameters (e.g., 4.5k), has an observation space configured to have dimensions (8, 128). The LLC observation may be flattened, and the latest (e.g., eight) observations may be stacked to form the observation.

To train the style policy, a general-purpose forchand and backhand LLC policy 126 may be selected, and their weights may be frozen. Then, all available ball states, including reflections, may be selected, and the style policy may be trained to maximize the expected ball landing rate. Although the style policy was trained with rally ball states, it was found to generalize to serving ball states. Therefore, a single policy may be utilized for both serving and rallying phases of a game.

In FIG. 5, once per ball hit, HLC 124 may decide which LLC 554 to return the ball with by first applying a style policy to the current ball state at block 550 to determine forchand or backhand (in this example choosing forehand is demonstrated). If the ball is a serve, at block 552, HLC 124 may attempt to classify the spin as topspin or backspin and pick the corresponding LLC 554 (e.g., “forchand top spin,” “forchand back spin,” “backhand top spin,” or “backhand back spin”). Otherwise HLC 124 may determine which of the many rallying LLCs will perform best by finding the most similar ball state within the corresponding set of LLC skill descriptions (e.g., “forchand LLC descriptions” in FIG. 5, 128B in FIG. 4) and getting the return statistics. Heuristic strategies 557 may be applied to these statistics and produce a shortlist 558 of candidate LLCs. The final chosen LLC 554 may be chosen through a weighted selection (e.g., using “online LLC preferences”). The chosen LLC 554 may be queried at 50 Hz with the current ball state to determine the robot actions 556.

LLC skill descriptors (128B in FIG. 4) may provide detailed metrics to HLC 124 on the estimated performance of each LLC for a given incoming ball. These descriptors may represent a model of the agent's own capabilities and, in conjunction with a model of an opponent and current game play, may form the foundation of strategic decision making.

To create the descriptors, each LLC 128 may be evaluated in simulation on some number (e.g., 28,000) ball states, with performance averaged over ten repetitions. The following policy metadata may be recorded: initial ball position and velocity; post-paddle median hit velocity, also referred to as hit velocity; ball landing location and standard deviation on the opponent's side; and/or ball landing rate, also referred to as land rate.

This metadata may be used to construct lookup tables, such as KD-Trees, where keys may represent initial ball position and velocity. Given any ball in play, the table may be queried for information about the likely performance of each LLC.

A sim-to-real gap has been observed even with high zero-shot transfer rates per LLC. Hit rates in the real world were high, however ball return rates, while acceptable, were lower than the return rates typically observed in simulation, which were greater than 80%. One common failure mode involved the LLC hitting the ball just over the edge of the table. This sim-to-real gap indicated that constructing skill descriptors using only simulated data was likely to lead to errors.

To address this, each LLC's skill descriptor was updated utilizing real-world data. Four researchers played with the robot, with HLC 124 configured to randomly select an LLC 128 to ensure roughly equal sampling. This resulted in a range of 91 to 257 real-world ball throws per LLC. For each LLC and for each collected ball, the twenty-five nearest neighbors in the relevant LLC-specific tree were updated. The simulated metrics and real-world metrics for a single ball throw were weighted equally, based on the assumption that the real-world data more accurately reflected expected performance.

In some implementations, for each opponent, HLC 124 may collect statistics pertaining to which balls were returned, based on the region of the table where the ball was received (forchand, backhand, or center). Each time HLC 124 initiates an action, a shortlist (558 in FIG. 5) of the most promising LLC candidates is generated. In some implementations, this shortlist 558 may be derived from a set of five hand-coded heuristics, with one candidate per heuristic. The selection process may consider the output from the style policy and information gathered about the opponent's ability to return balls, both in total and broken down by forehand, backhand, and center returns. Information regarding the opponent is persisted between games played with the same opponent. It should be noted that not all heuristics utilize all available information.

In some implementations, heuristics such as the following may be employed. With random selection, an LLC 128 may be randomly selected if its landing rate exceeds a predetermined threshold. With prioritization of hit velocity, he top “m” LLCs with the fastest hit velocities may be selected, provided that their landing rates are among the top “n”. With prioritization of landing distance, the top “m” LLCs with the farthest landing positions from the initial ball state may be selected, provided that their landing rates are among the top “n”. With exploitation of an opponent's weak side (backhand or forchand), an LLC 128 that targets the opponent's weaker side may be selected.

For opponents demonstrating high skill levels, it may be assumed that a ball can be returned from any position on their side. If an opponent's return rate exceeds a predefined percentage, the farthest landing position for a given ball state may be selected. This selection may be based on the assumption that such a placement may compel the opponent to exert greater effort to return the ball. Otherwise, the LLC with the highest landing rate may be selected. From the generated shortlist, the LLC to be utilized (554 in FIG. 5) for returning the ball may be selected using weighted sampling, which may be implemented to reduce the predictability of the robot's actions.

LLC preferences (e.g., H-value) may factor into choosing an LLC in some cases as follows. A numerical preference for each LLC, denoted as H (LLC), may be determined based on the LLC's online performance. HLC 124 may select LLCs more often if their preference is higher. However, the preference itself may have no connection to reward; only the relative preference between LLCs 128 may matter. Preferences may be determined during each match using a gradient bandit algorithm, which evaluates actions based on their associated rewards and updates preferences proportionally to the difference between the observed reward and a baseline, scaled by a step size.

As shown in FIG. 5, a shortlist 558 of candidate LLCs 128 is created for each ball. Each candidate may be associated with an offline return rate and online preferences for selecting an LLC 128. It has been observed that combining learned H-values with information from skill descriptor tables may play an important role in improving performance. These H-values may serve a variety of purposes. One is online sim-to-real correction: even though efforts may be made through offline updates to the skill descriptor tables, a sim-to-real gap may remain. This may be due to the sample of real-world balls used to update the tables being limited and generated by a small number of players. These values may allow the policy to quickly switch away from poor-performing LLCs to more stable ones. Another purpose of H-values may be to identify player-specific strengths and weaknesses: If a current opponent is able to easily return shots that one LLC 128 struggles to return, HLC 124 may shift weight to another LLC that the opponent can less easily exploit.

To update the preferences, each time an LLC 128 is selected, the H-value may be updated using the binary ball land signal as the reward function. For each new opponent, these values may be initialized to a set of known baseline preferences, to ensure consistent initial component selection. These preferences may be updated and persisted across games for the same opponent.

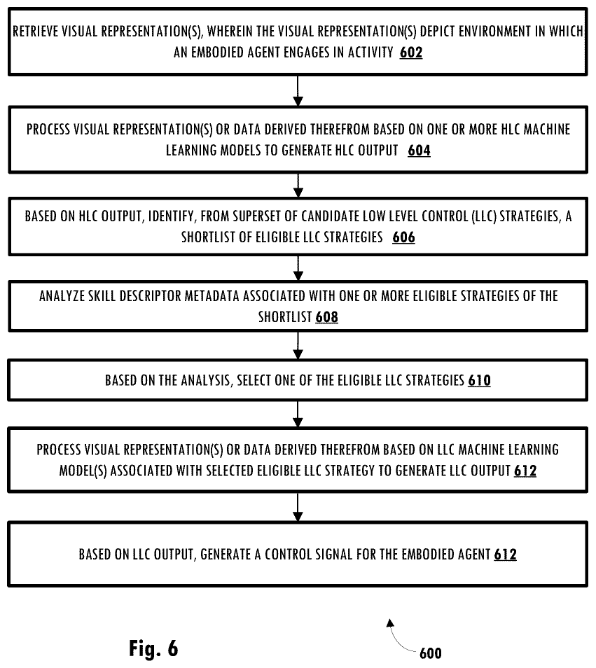

FIG. 6 depicts a flowchart depicting an example method 600 for carrying out selected aspects of the present disclosure in accordance with one implementation of the present disclosure. Although the blocks are illustrated in a sequential order, these blocks may in some instances be performed in parallel, and/or in a different order than those described herein. Also, the various blocks may be combined into fewer blocks, divided into additional blocks, and/or removed based upon the desired implementation. For convenience and without limitation, the method 600 is described with reference to the system that carries out the operations.

At block 602, the system may retrieve one or more visual representations captured by one or more vision sensors (e.g., 108-1 to 108-M, vision sensors external to robot 100, etc.). The one or more visual representations may depict an environment in which an embodied agent (such as robot 100 or 300) engages in an activity. For example, the visual representations may be captured by a vision sensor onboard the robot (100) or by a vision sensor deployed in the environment independently of the embodied agent. The visual representations may include a digital image captured by a digital camera or a point cloud captured by a light detection and ranging (LIDAR) sensor. The embodied agent may be a physical robot (100) and the environment may be a physical environment. Alternatively, the embodied agent may be a virtual robot and the environment may be a simulated environment. In some implementations, one or more of the visual representations may depict an incoming ball.

At block 604, the system may process one or more of the visual representations—and/or data derived therefrom, such as ball positions and velocity over time—based on one or more HLC machine learning models (122) to generate HLC output. In some implementations, one or more of the HLC machine learning models (122) may include a CNN, such as a dilated-gated CNN. In some implementations, a generative model, such as a VLM, may be included. In some cases the activity may include a racket sport involving the embodied agent and one or more other co-participants (340). In such instances, the HLC output may identify a HLC style including forchand or backhand. The activity may alternatively include locomotion by the robot, and the HLC output may identify a HLC style selected from a plurality of gait styles of the robot. The activity may alternatively include manipulation by the robot of one or more objects, where the manipulation may include a grasp of one or more of the objects by the robot. The HLC output may identify a HLC style selected from a plurality of grip styles of the robot, or one or more target grasp points of one or more of the objects. The activity may also include interaction of the robot with one or more humans. In some instances, the activity may include throwing or catching an object, and the HLC output may identify a HLC style including one or more of overhand, underhand, or side arm, or a HLC style including hard throw or soft toss.

At block 606, based on the HLC output, the system may identify, from a superset of candidate low level control (LLC) strategies, a shortlist (558) of two or more eligible LLC strategies.

At block 608, the system may analyze skill descriptor metadata (128A) associated with one or more eligible LLC strategies of the shortlist (558). In some implementations, the skill descriptor metadata (128A) associated with a given eligible LLC strategy of the shortlist may include empirical data about observed historical performance of the given eligible LLC strategy. This skill descriptor metadata (128A) may be stored in a lookup table or as a lookup tree. The activity may include a racket sport, such as table tennis. In such instances, the skill descriptor associated with a given eligible LLC strategy of the shortlist may include one or more of initial ball position and/or velocity, hit velocity, ball landing location, or ball landing rate.

At block 610, based on the analyzing, the system may select one (554) of the shortlist (558) of two or more eligible LLC strategies. The selection may be based at least in part on obtained empirical data about a co-participant (340) in the activity. This empirical data may be used to update the skill descriptor metadata (128A). The co-participant (340) may include a human participating in the activity with the embodied agent, or another embodied agent participating in the activity with the embodied agent. A preference associated with the activity may be determined based on the obtained empirical data, and the selection may be based at least in part on this preference. In some cases, the preference may be represented as a q-value. In some implementations, one of the shortlist (558) of two or more eligible LLC strategies may be selected at least partially at random.

At block 612, the system may process one or more of the visual representations—or data derived therefrom, based on one or more LLC machine learning models (126) associated with the selected eligible LLC strategy (554) to generate LLC output. In some implementations, one or more of the LLC machine learning models (126) may include a CNN such as a dilated-gated CNN.

At block 614, based on the LLC output, the system may generate a control signal for the embodied agent. This control signal may be used at block 616 to operate robot 100/300.

FIG. 7 is a block diagram of an example computing device 710 that may optionally be utilized to perform one or more aspects of techniques described herein. Computing device 710 typically includes at least one processor 714 which communicates with a number of peripheral devices via bus subsystem 712. These peripheral devices may include a storage subsystem 724, including, for example, a memory subsystem 725 and a file storage subsystem 726, user interface output devices 720, user interface input devices 722, and a network interface subsystem 716. The input and output devices allow user interaction with computing device 710. Network interface subsystem 716 provides an interface to outside networks and is coupled to corresponding interface devices in other computing devices.

User interface input devices 722 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computing device 710 or onto a communication network.

User interface output devices 720 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 710 to the user or to another machine or computing device.

Storage subsystem 724 stores programming and data constructs that provide the functionality of some or all of the modules described herein. For example, the storage subsystem 724 may include the logic to perform selected aspects of the methods described herein.

These software modules are generally executed by processor 714 alone or in combination with other processors. Memory 725 used in the storage subsystem 724 can include a number of memories including a main random access memory (RAM) 730 for storage of instructions and data during program execution and a read only memory (ROM) 732 in which fixed instructions are stored. A file storage subsystem 726 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 726 in the storage subsystem 724, or in other machines accessible by the processor(s) 714.

Bus subsystem 712 provides a mechanism for letting the various components and subsystems of computing device 710 communicate with each other as intended. Although bus subsystem 712 is shown schematically as a single bus, alternative implementations of the bus subsystem may use multiple busses.

Computing device 710 can be of varying types including a workstation, server, computing cluster, blade server, server farm, or any other data processing system or computing device. Due to the ever-changing nature of computers and networks, the description of computing device 710 depicted in FIG. 7 is intended only as a specific example for purposes of illustrating some implementations. Many other configurations of computing device 710 are possible having more or fewer components than the computing device depicted in FIG. 7.

In various implementations, a method may be performed using one or more processors. One or more visual representations, which may be captured by one or more vision sensors, may be retrieved. The one or more visual representations may depict an environment in which an embodied agent engages in an activity. One or more of the visual representations, or data derived therefrom, may be processed based on one or more high-level control (HLC) machine learning models to generate HLC output. Based on the HLC output, a shortlist of two or more eligible low-level control (LLC) strategies may be identified from a superset of candidate LLC strategies. Skill descriptor metadata associated with one or more eligible LLC strategies of the shortlist may be analyzed. Based on the analysis, one of the two or more eligible LLC strategies may be selected. One or more of the visual representations, or data derived from the visual representations, may then be processed based on one or more LLC machine learning models associated with the selected eligible LLC strategy to generate LLC output. Based on the LLC output, a control signal for the embodied agent may be generated.

In various implementations, the skill descriptor metadata associated with a given eligible LLC strategy of the shortlist may include empirical data about observed historical performance of the given eligible LLC strategy. The skill descriptor metadata may be stored in a lookup table or as a lookup tree. In some examples, empirical data about a co-participant in the activity may be obtained. The selection may be based at least in part on the obtained empirical data. The skill descriptor metadata may be updated based on the obtained empirical data. The co-participant may include a human participating in the activity with the embodied agent. Alternatively, the co-participant may include another embodied agent participating in the activity with the embodied agent. A preference associated with the activity may be determined based on the obtained empirical data. The selection may be based at least in part on this preference. The preference may be represented as a q-value.

In various implementations, the activity may include a racket sport involving the embodied agent and one or more other co-participants. The HLC output may identify an HLC style including forehand or backhand. One or more of the visual representations may depict an incoming ball. The skill descriptor associated with a given eligible LLC strategy of the shortlist may include one or more of initial ball position or velocity, hit velocity, ball landing location, or ball landing rate. The racket sport may include table tennis.

In various implementations, the embodied agent may include a robot. The activity may include locomotion by the robot. The HLC output may identify an HLC style selected from a plurality of gait styles of the robot. The activity may include manipulation by the robot of one or more objects. The manipulation may include a grasp of one or more of the objects by the robot. The HLC output may identify an HLC style selected from a plurality of grip styles of the robot. The HLC output may also identify one or more target grasp points of one or more of the objects. The activity may include interaction of the robot with one or more humans. The activity may include throwing or catching an object. The HLC output may identify an HLC style including one or more of overhand, underhand, or side arm. The HLC output may identify an HLC style including hard throw or soft toss.

In various implementations, the generative model may include a vision language model (VLM). One or more of the HLC machine learning models may include a convolutional neural network (CNN). One or more of the LLC machine learning models may include a convolutional neural network (CNN). The CNN may include a dilated-gated CNN.

In various implementations, one of the two or more eligible LLC strategies may be selected at least partially at random. One or more of the visual representations may be captured by a vision sensor onboard a robot. One or more of the visual representations may be captured by a vision sensor deployed in the environment independently of the embodied agent. One or more of the visual representations may include a digital image captured by a digital camera. One or more of the visual representations may include a point cloud captured by a light detection and ranging (LIDAR) sensor. One or more of the visual representations may include a screenshot. The embodied agent may be a physical robot and the environment may be a physical environment. Alternatively, the embodied agent may be a virtual robot and the environment may be a simulated environment.

In various implementations, a system may include one or more processors and memory storing instructions that, in response to execution by the one or more processors, may cause the one or more processors to perform any of the methods described herein.

In various implementations, at least one non-transitory computer-readable medium may include instructions that, in response to execution by one or more processors, may cause the one or more processors to perform any of the methods described herein.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A method implemented using one or more processors and comprising:
retrieving one or more visual representations captured by one or more vision sensors, wherein the one or more visual representations depict an environment in which an embodied agent engages in an activity;
processing one or more of the visual representations, or data derived from one or more of the visual representations, based on one or more high level control (HLC) machine learning models to generate HLC output;
based on the HLC output, identifying, from a superset of candidate low level control (LLC) strategies, a shortlist of two or more eligible LLC strategies;
analyzing skill descriptor metadata associated with one or more eligible LLC strategies of the shortlist;
based on the analyzing, selecting one of the two or more eligible LLC strategies; and
processing one or more of the visual representations, or data derived from one or more of the visual representations, based on one or more LLC machine learning models associated with the selected eligible LLC strategy to generate LLC output; and
based on the LLC output, generating a control signal for the embodied agent.

2. The method of claim 1, wherein the skill descriptor metadata associated with a given eligible LLC strategy of the shortlist includes empirical data about observed historical performance of the given eligible LLC strategy.

3. The method of claim 1, wherein the skill descriptor metadata is stored in a lookup table.

4. The method of claim 1, wherein the skill descriptor metadata is stored in memory as a lookup tree.

5. The method of claim 1, further comprising obtaining empirical data about a co-participant in the activity, wherein the selecting is based at least in part on the obtained empirical data.

6. The method of claim 5, further comprising updating the skill descriptor metadata based on the obtained empirical data.

7. The method of claim 5, wherein the co-participant comprises a human participating in the activity with the embodied agent.

8. The method of claim 5, wherein the co-participant comprises another embodied agent participating in the activity with the embodied agent.

9. The method of claim 5, further comprising determining a preference associated with the activity based on the obtained empirical data, wherein the selecting is based at least in part on the preference.

10. The method of claim 9, wherein the preference is represented as a q-value.

11. The method of claim 1, wherein the activity comprises a racket sport involving the embodied agent and one or more other co-participants.

12. The method of claim 11, wherein the HLC output identifies a HLC style comprising forehand or backhand.

13. The method of claim 11, wherein one or more of the visual representations depicts an incoming ball.

14. The method of claim 11, wherein the skill descriptor associated with a given eligible LLC strategy of the shortlist comprises one or more of:
initial ball position and/or velocity;
hit velocity;
ball landing location; or
ball landing rate.

15. The method of claim 11, wherein the racket sport comprises table tennis.

16. The method of claim 1, wherein the embodied agent comprises a robot.

17. The method of claim 16, wherein the activity comprises locomotion by the robot.

18. The method of claim 17, wherein the HLC output identifies a HLC style selected from a plurality of gait styles of the robot.

19. The method of claim 16, wherein the activity comprises manipulation by the robot of one or more objects, and the manipulation comprises a grasp of one or more of the objects by the robot.

20. A system comprising one or more processors and memory storing instructions that, in response to execution by the one or more processors, cause the one or more processors to:
retrieve one or more visual representations captured by one or more vision sensors, wherein the one or more visual representations depict an environment in which an embodied agent engages in an activity;
process one or more of the visual representations, or data derived from one or more of the visual representations, based on one or more high level control (HLC) machine learning models to generate HLC output;
based on the HLC output, identify, from a superset of candidate low level control (LLC) strategies, a shortlist of two or more eligible LLC strategies;
analyze skill descriptor metadata associated with one or more eligible LLC strategies of the shortlist;
based on the analysis, select one of the two or more eligible LLC strategies; and
process one or more of the visual representations, or data derived from one or more of the visual representations, based on one or more LLC machine learning models associated with the selected eligible LLC strategy to generate LLC output; and
based on the LLC output, generate a control signal for the embodied agent.
